(19) United States
(12) Patent Application Publication
(10) Pub. No.: US 2019/0194004 A1
(43) Pub. Date: Jun. 27, 2019

(54) LOCKING SYSTEM FOR A WORKING MACHINE

(71) Applicant: J.C. Bamford Excavators Limited, Uttoxeter (GB)

(72) Inventor: Jonathan Kenred Bailey, Uttoxeter (GB)

(73) Assignee: J.C. Bamford Excavators Limited, Uttoxeter (GB)

(21) Appl. No.: 16/224,343

(22) Filed: Dec. 18, 2018

(30) Foreign Application Priority Data
Dec. 22, 2017 (GB) 1721705.0

(51) Int. Cl. B66F 9/075; B66F 9/22; E02F 3/36

(52) U.S. Cl. CPC B66F 9/075; B66F 9/22; B66F 9/0655; E02F 3/3663; E02F 3/3631

(57) ABSTRACT

A locking system for securing an attachment to a working arm of a working machine, the locking system including a latch member movable between an engaged position, where the attachment is secured to said working arm, and a disengaged position, where the attachment can be removed from said working arm; and a hydraulic circuit configured to lock the latch member in the engaged position. The hydraulic circuit includes a lock configured to open when the circuit reaches a predetermined pressure such that the latch member is released from the engaged position, a relief valve configured to activate below the predetermined pressure, such that the lock remains closed in normal operation, and an isolation arrangement configured to selectively isolate the relief valve from the circuit upon an operator input, to enable the circuit to reach the predetermined pressure such that the latch member is released.

### FIELD OF THE INVENTION

The present invention relates to a locking system for securing an attachment to a working arm of a working machine, to a working machine comprising a locking system, and to a method of disengaging a latch member of a locking system.

### BACKGROUND OF THE INVENTION

A range of interchangeable attachments are commonly provided for use with a working machine, allowing such a machine to be used for a number of different functions. Such attachments have a standard connection arrangement that allows them to be fitted to a common mounting on a working arm of the working machine. For example, attachments such as forks, buckets or sweepers can be interchanged on a working machine.

Such attachments are usually secured in place at the free end of the working arm by a pair of pins that extend to engage apertures on the attachment under the control of a hydraulic ram. When the attachment is to be detached from the working arm, the ram retracts and the pins disengage the apertures. The attachment can then be removed from the working arm.

Inadvertent detachment of the attachment presents a safety risk. In order to avoid inadvertent detachment of the attachment, the pins should be locked in the extended, engaged position. It is known to lock the pins in the engaged position by means of a manually-operated lock, such as a manually operated tap on the hydraulic line, at the end of the working arm. However, operation of such a lock is time consuming, as the operator of the working machine must leave the cab of the working machine in order to actuate the lock.

It is also known to provide a remotely-operated lock for the pins, in the form of an electronic locking system. This allows the operator to release the pins from the engaged position from the cab. However, such a system requires a relatively delicate electronic harness connection at the free end of the working arm, which is difficult and expensive to install and can easily become damaged, sometimes without the knowledge of the operator. It is also difficult to replicate this system across a whole range of working machines, due to the technical challenges of installing the electronic harness connection at the free end of the working arm.

The present invention seeks to overcome or at least mitigate one or more of the problems associated with the prior art.

### SUMMARY OF THE INVENTION

A first aspect of the invention provides a locking system for securing an attachment to a working arm of a working machine. The locking system comprises a latch member movable between an engaged position, where the attachment is secured to said working arm, and a disengaged position, where the attachment can be removed from said working arm; and a hydraulic circuit configured to lock the latch member in the engaged position. The hydraulic circuit comprises a lock configured to open when the circuit reaches a predetermined pressure such that the latch member is released from the engaged position; a relief valve configured to activate below the predetermined pressure, such that the lock remains closed in normal operation; and an isolation arrangement configured to selectively isolate the relief valve from the circuit upon an operator input, to enable the circuit to reach the predetermined pressure such that the latch member is released.

Providing a relief valve that can be isolated from the remainder of the circuit provides a simple and effective means of releasing the latch member, in an arrangement that can advantageously be retro-fitted to an existing working machine, or incorporated into the hydraulic system of a new machine at low cost.

The lock may comprise a mechanical valve. The lock comprising a mechanical valve avoids the need for an electronic harness connection at the location of the attachment, where damage is more likely to take place. In addition, there is no requirement for a complicated and expensive installation at the free end of the working arm.

The lock may comprise a check valve. A check valve is a simple, effective and reliable form of mechanical valve that can be easily configured to open when the circuit reaches a predetermined pressure.

The hydraulic circuit may comprise a pilot line configured to operate the lock. The pilot line aids control of opening and closing the lock.

The isolation arrangement for the relief valve may be configured for remote operation. Remote operation of the isolation arrangement allows the latch member to be released without the operator leaving the cab.

The isolation arrangement may comprise an electromechanical valve. The electromechanical valve may be a solenoid valve. A solenoid valve provides a reliable switching means for isolating the relief valve from the remainder of the circuit.

The pressure differential between the predetermined pressure and the activation pressure of the relief valve may be more than 1,000,000 Pa (10 bar).

The pressure differential between the activation pressure of the main relief valve and the predetermined pressure at which the lock will open may be more than 1,000,000 Pa (10 bar).

The predetermined pressure may be between 23000000 Pa (230 bar) and 24000000 Pa (240 bar).

The relief valve activation pressure may be between 21500000 Pa (215 bar) and 22500000 Pa (225 bar).

The system may further comprise a latch member actuator configured to move the latch member between the engaged and disengaged positions.

The system may further comprise a first user input for operating the isolation arrangement, and a second user input for operating the latch member actuator, where the first and second user inputs are spaced such that they cannot be operated by a single hand.

The first user input may be at least 200mm from the second user input.

Advantageously, two actions must be taken to disengage the latch member, i.e. releasing the latch member using the isolation arrangement, and operating the latch member actuator. An operator must use both hands to operate the first and second user inputs for these actions, reducing the likelihood of inadvertent disengagement of the latch member.

The hydraulic locking circuit may form part of an auxiliary circuit configured to selectively supply hydraulic fluid to an attachment to provide a function of the attachment.

The locking circuit forming part of an existing circuit reduces complexity, saving cost and space.

There is also provided a working machine comprising a working arm for mounting attachments thereto; and a locking system as described above.

The isolation arrangement may be located on a valve block located on a main body of the working machine.

The relief valve may be located on a valve block located on a main body of the working machine. The lock may be located proximal the free end of the working arm.

The locking system may comprise a latch member actuator configured to move the latch member between the engaged and disengaged positions; a first user input for operating the isolation arrangement; and a second user input for operating the latch member actuator. The first and second user inputs may be operable by an operator seated in an operator seat of the working machine without leaving the operator seat.

The first and second user inputs may be spaced such that they cannot be operated by a single hand.

There is further provided a method of disengaging a latch member of a locking system as described above, the method comprising the steps of:
a) isolating the relief valve from the circuit; and
b) moving the latch member to a disengaged position.

Another aspect of the invention provides a hydraulic circuit configured to operate a function of a working machine. The hydraulic circuit comprises a control valve configured to open when the circuit reaches a predetermined pressure such that the function is operated; a relief valve configured to activate below the predetermined pressure, such that the valve remains closed in normal operation; and an isolation arrangement configured to selectively isolate the relief valve from the circuit upon an operator input, to enable the circuit to reach the predetermined pressure such that the function is operated.

Providing a relief valve that can be isolated from the remainder of the circuit provides a simple and effective means of operating a function of a working machine, in an arrangement that can advantageously be retro-fitted to an existing working machine, or incorporated into the hydraulic system of a new machine at low cost.

The control valve may comprise a mechanical valve. The control valve comprising a mechanical valve avoids the need for an electronic harness connection at the location of the function. In addition, there is no requirement for a complicated and expensive installation at the location of the function.

The control valve may comprise a check valve. A check valve is a simple, effective and reliable form of mechanical valve that can be easily configured to open when the circuit reaches a predetermined pressure.

The hydraulic circuit may comprise a pilot line configured to operate the control valve. The pilot line aids control of opening and closing the valve.

The isolation arrangement for the relief valve may be configured for remote operation. Remote operation of the isolation arrangement allows operation of the function without the operator leaving the cab.

The isolation arrangement may comprise an electromechanical valve. The electromechanical valve may be a solenoid valve. A solenoid valve provides a reliable switching means for isolating the relief valve from the remainder of the circuit.

The predetermined pressure may be between 23000000 Pa (230 bar) and 24000000 Pa (240 bar).

The relief valve activation pressure may be between 21500000 Pa (215 bar) and 22500000 Pa (225 bar).

The predetermined pressure may be between 23000000 Pa (230 bar) and 24000000 Pa (240 bar).

The relief valve activation pressure may be between 21500000 Pa (215 bar) and 22500000 Pa (225 bar).

The system may further comprise a first user input for operating the isolation arrangement, and a second user input for operating the function, where the first and second user inputs are spaced such that they cannot be operated by a single hand.

The first user input may be at least 200mm from the second user input.

Advantageously, two actions must be taken to operate the function. An operator must use both hands to operate the first and second user inputs for these actions, reducing the likelihood of inadvertent operation of the function.

The hydraulic locking circuit may form part of an auxiliary circuit configured to selectively supply hydraulic fluid to an auxiliary attachment to provide a function of the attachment.

The locking circuit forming part of an existing circuit reduces complexity, saving cost and space.

There is also provided a working machine comprising a function; and a hydraulic circuit as described above.

The isolation arrangement may be located on a valve block located on a main body of the working machine.

The relief valve may be located on a valve block located on a main body of the working machine. The control valve may be located proximal the free end of the working arm.

The hydraulic circuit may comprise a first user input for operating the isolation arrangement; and a second user input for operating the function. The first and second user inputs may be operable by an operator seated in an operator seat of the working machine without leaving the operator seat.

The first and second user inputs may be spaced such that they cannot be operated by a single hand.

There is further provided a method of operating a function of a working machine as described above, the method comprising the steps of:
a) isolating the relief valve from the circuit; and
b) operating the function.

### BRIEF DESCRIPTION OF THE DRAWINGS

Embodiments of the invention will now be described with reference to the accompanying drawings, in which:

FIG. 1 is a side view of a working machine with a locking system according to an embodiment of the invention;

FIG. 2 is a perspective view of an attachment for a working machine with part of the locking system of the embodiment of FIG. 1;

FIG. 3 is a perspective view of a carriage for an attachment for a working machine with the locking system of the embodiment of FIGS. 1 and 2, with an alternative ram arrangement;

FIG. 4 is a schematic view of the locking system of the embodiment of FIGS. 1 to 3; and

FIG. 5 is a schematic view of a locking system according to a further embodiment of the invention.

### DETAILED DESCRIPTION OF EMBODIMENT(S)

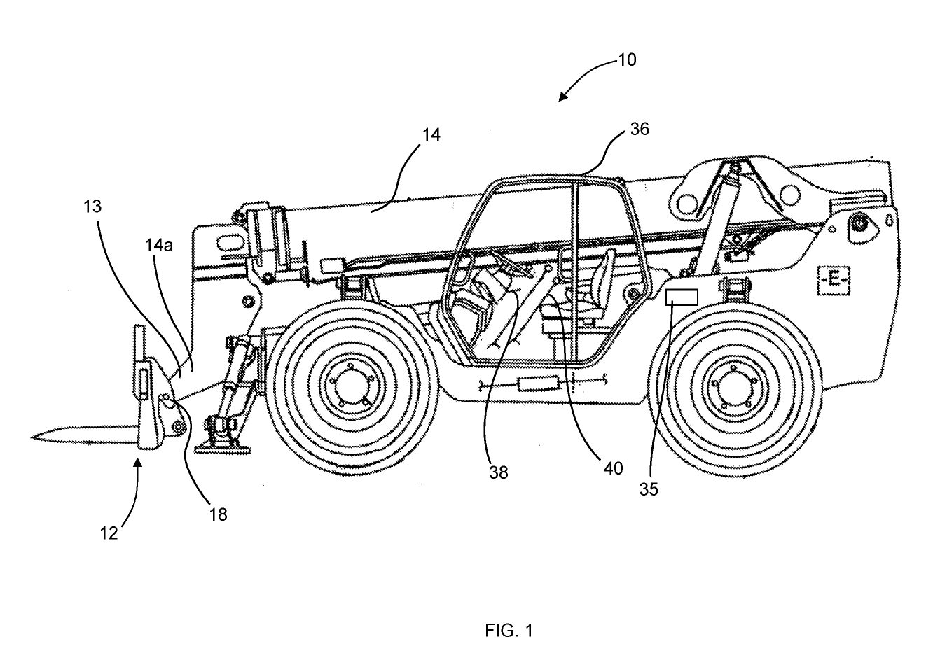

FIG. 1 shows a working machine generally indicated at 10. The working machine 10 shown in FIG. 1 is of the type known as a telehandler or telescopic handler, with an interchangeable attachment 12 mounted to a free end 14a of a working arm in the form of a telescopic boom 14. However, the invention is applicable to other types of working machine where interchangeable attachments are used, such as wheel loaders, excavators and the like.

Different types of attachment 12 can be mounted to the working machine 10, depending on the required function. FIG. 1 shows an attachment in the form of a fork 12. However, other types of attachment such as a bucket or a sweeper, or some other suitable attachment, can be mounted to the working machine in place of the fork 12 shown.

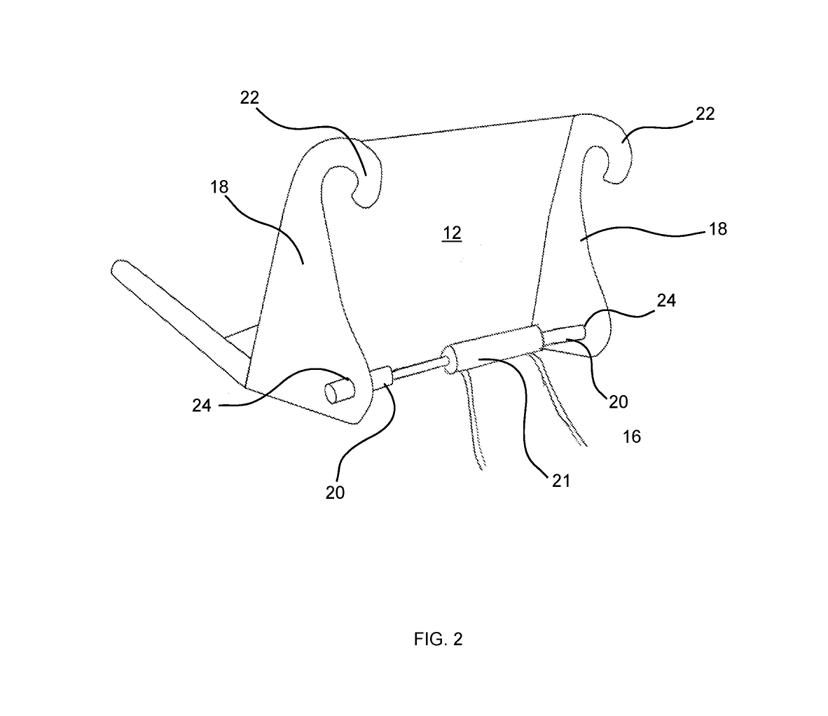

The attachment 12 is mounted to the free end 14a of the working arm 14 and secured by a locking system 16, as shown in more detail in FIGS. 2, 3 and 4. The locking system 16 is configured to interact with a connection arrangement 18 on the attachment 12. Such a locking system 16 can be provided on the range of working machines described above for use with the range of attachments described, so allowing different attachments to be secured to different working machines.

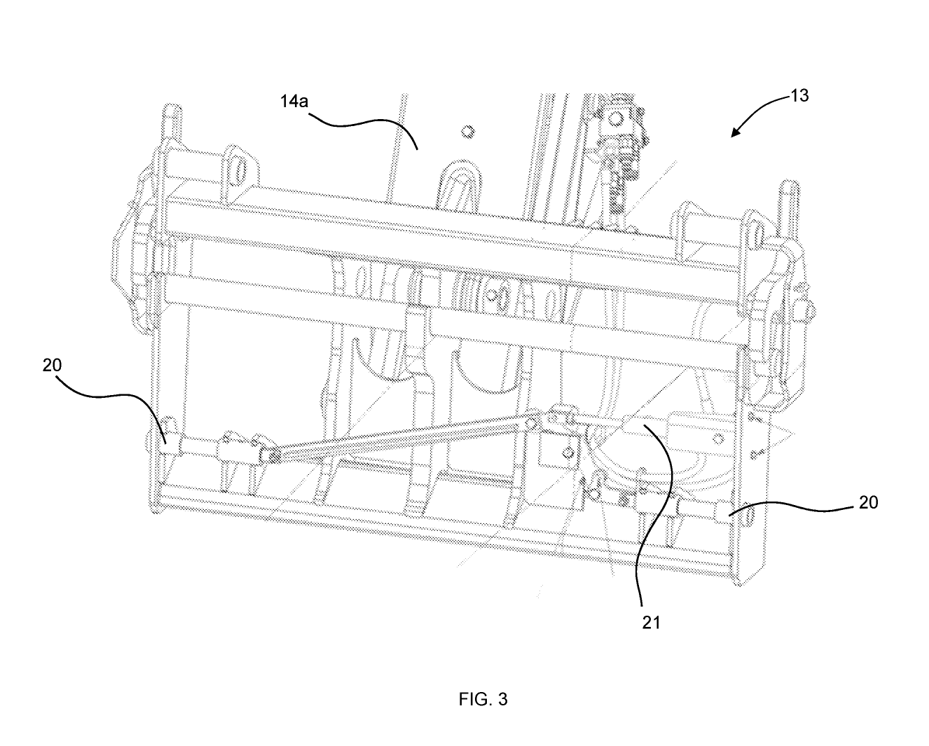

The locking system 16 has a pair of latch members or pins 20 that are mounted to the working arm 14 (other components of the working arm are not shown in FIG. 2, to improve clarity). The pins 20 are movable between an engaged position, as shown in FIGS. 2 and 3, where the attachment is secured to the working arm 14, and a disengaged position, where the attachment 12 can be removed from the working arm 14. In the engaged position, the pins 20 are extended to engage a corresponding engagement feature of the attachment connection arrangement 18.

In this embodiment, the connection arrangement 18 has a pair of hooks 22 and a pair of apertures 24. The hooks 22 are configured to support the attachment 12 on a carriage 13 on the free end 14a of the working arm 14. The apertures 24 provide the engagement feature of this embodiment, and are configured for engagement by the pins 20. To reach the disengaged position, the pins 20 are retracted from the apertures 24, and the attachment 12 can be removed from the working arm 14.

In this embodiment, the pins 20 and the apertures 24 are substantially circular in cross-section. In alternative embodiments, the pins 20 and the apertures 24 are of some other suitable complementary shape. In alternative embodiments, some other type of feature is provided for engagement by the pins 20, such as a fitting.

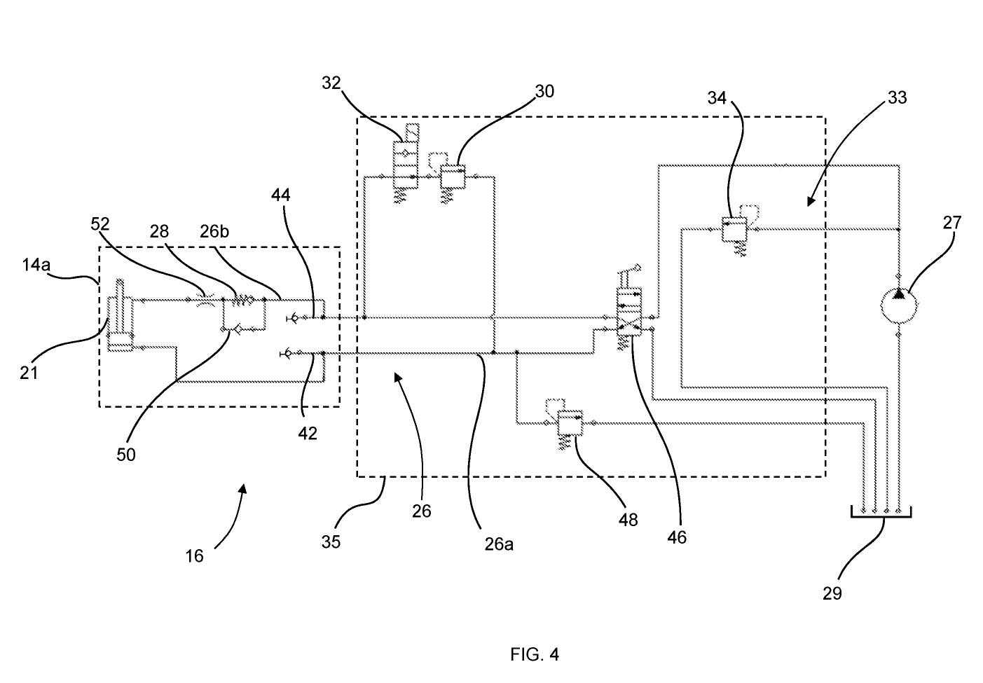

The pins 20 are operated by a latch member actuator or ram 21 controlled by an auxiliary hydraulic circuit 26, as shown in FIG. 4. The circuit 26 is supplied with hydraulic fluid under pressure by a hydraulic pump 27, and has a fluid reservoir 29. The circuit 26 has a first path 26a, on a first side of the ram 21, and a second path 26b, on a second side of the ram 21.

The hydraulic circuit 26 includes a lock 28 that locks the ram 21 so that the pins 20 are in the engaged position. That is, the lock 28 blocks hydraulic fluid flow to prevent the pins 20 being moved from the engaged position. The lock 28 is configured to open when the circuit 26 reaches a predetermined pressure. When the lock 28 opens, the ram 21 is released, and the pins 20 can be moved to the disengaged position so that the attachment 12 can be removed.

In this embodiment, the lock 28 is on the second path 26b of the circuit 26. Opening of the lock 28 allows hydraulic fluid to operate the ram 21, so that the pins 20 are moved towards the disengaged position.

The lock of this embodiment is a mechanical valve 28. In this embodiment, the lock is a spring-loaded check valve 28. The check valve 28 provides a simple and effective lock that will open only when the circuit reaches the predetermined pressure. The check valve 28 is inherently safe, as the spring resiliently biases a ball into a seat. The check valve 28 has no external moving parts, so is protected from damage. The check valve 28 is adjustable. Springs of different resilience can be used to set the locking system 16 to operate at a range of pressures, depending on the architecture and normal pressure of a particular working machine.

The check valve 28 of this embodiment is set to open when the circuit reaches a pressure of 23,500,000 Pa (235 bar), as described above. That is, the cracking pressure of the check valve 28 is 23,500,000 Pa (235 bar). In alternative embodiments other suitable types of check valve, or other suitable mechanical valves, are used.

The lock 28 is in this embodiment located at the free end 14a of the working arm 14. Being a mechanical valve, the lock is less likely to be damaged at this location than a more delicate electromechanical valve.

The lock 28 remains closed by default due to a relief valve 30 arranged to prevent the second path 26b reaching the predetermined pressure. To achieve this, the relief valve 30 is configured to activate at a pressure below the predetermined pressure of the lock 28. The relief valve 30 will therefore activate and relieve the second path 26b pressure before the second path 26b pressure is high enough to activate the lock 28.

For example, in this embodiment, the predetermined pressure at which the lock 28 activates is 23,500,000 Pa (235 bar). The relief valve 30 is set to activate at a pressure of 22,000,000 Pa (220 bar). The lock 28 will not therefore activate whilst the relief valve 30 is part of the circuit 26.

The circuit 26 has a free flow return valve 50 in parallel with the check valve 28, allowing fluid to flow around the check valve 28 in the return direction when the check valve 28 is closed.

The circuit 26 has a restrictor 52 adjacent the check valve 28. The restrictor 52 slows the speed of movement of the ram 21, by restricting the amount of fluid that reaches the ram 21.

In order to open the lock 28 to release the ram 21, the relief valve 30 is isolated from the circuit 26. An isolation arrangement 32 is provided as part of the circuit 26. The isolation arrangement 32 is located on a main valve block 35 of the working machine 10. When activated by the operator of the working machine 10, the isolation arrangement 32 removes the relief valve 30 from the circuit 26. The pressure at the second path 26b can then be increased to the lock 28 activation pressure, so that the lock 28 is opened. The ram 21 is then released. That is, the ram 21 is no longer locked with the pins 20 in the engaged position, allowing the operator to operate the ram 21 so as to move the pins 20 to the disengaged position. The attachment 12 can then be removed.

In this embodiment, the auxiliary hydraulic circuit 26 is connected to a main hydraulic circuit 33 of the working machine 10, which is used to operate the telescopic boom 14 or some other part of the working machine 10. The main hydraulic circuit has a main relief valve 34, located on the main valve block 35. The main relief valve 34 protects the circuit from excess pressure. The lock 28 activates at a pressure below the activation pressure of the main relief valve 34, so that the lock 28 will open before the main relief valve 34 is activated. In this embodiment, the main relief valve 34 activates at 24,000,000 Pa (240 bar), or in some embodiment, 26,000,000 Pa (260 bar).

Advantageously, the circuit 26 of this embodiment makes use of the pressure differential between the relief valve 30 and the main relief valve 34 to control locking of the ram 21. This use of existing circuits and valve arrangements is time and space efficient, and allows simple and inexpensive retrofitting of the locking system to existing working machines. The relief valve 30 and the isolation arrangement 32 can be independently plumbed between the main valve block 35 and the remainder of the locking system 16. The relief valve 30 and the isolation arrangement 32 can be fitted to a mechanical valve block with no existing electromechanical valves. The locking system can also be built into new working machines as part of the main valve block.

The isolation arrangement 32 of this embodiment is operated remotely, so that the operator does not need to leave the cab 36 of the working machine 10 to release the ram 21. The isolation arrangement of this embodiment is an electromechanical valve 32, arranged in series with the relief valve 30, which in this embodiment is pilot-operated. The electromechanical valve 32 is used to shut off flow to the relief valve 30 and so remove the relief valve 30 from the circuit 26. In this embodiment, the electromechanical valve is a normally open solenoid valve 32. In alternative embodiments, some other suitable type of electromechanical valve is used.

In an alternative embodiment the isolation arrangement is some other type of remotely operated valve, such as a pilot pressure operated valve, or a mechanically operated valve. In an alternative embodiment, the isolation arrangement is not operated remotely, e.g. it is operated manually. For example, a lever or tap could be used.

A first user input 38 located in the cab 36 is used to control the solenoid valve 32. When the solenoid valve 32 is to be closed, i.e. when the relief valve 30 is to be isolated from the circuit 26, the user input 38 is activated and an electric current is supplied to the solenoid valve 32, so that the solenoid valve 32 is closed. In this embodiment, the user input 38 must be continuously operated (e.g. depressed) in order for the solenoid valve 32 to be closed. That is, the operator must keep one hand on the user input 38 in order to release the ram 21. This safety feature helps to prevent inadvertent release of the pins 20.

The operator uses a second user input 40 to control movement of the ram 21 in order to move the pins 20 between the engaged and disengaged positions. Although shown as levers 38, 40 in FIG. 1, the first and second user inputs 38, 40 are in alternative embodiments in some other suitable form, such as a roller, or a spring-loaded rocker switch.

The first and second user inputs 38, 40 are separated from one another in the operator's cab 36, so that the operator must use two hands to disengage the pins 20 and detach the attachment 12—a first hand to operate the first user input 38, and a second hand to operate the second user input 40. The locking system 16 thus meets the safety requirement of standards BS EN 1459 and EN 1459 and equivalent standards to prevent unintentional lateral displacement and detachment of the attachment. In this embodiment, the first and second user inputs 38, 40 are spaced at least 200 mm from one another, so that they cannot be operated by a single hand. In alternative embodiments, the first and second user inputs 38, 40 are spaced at least 300 mm from one another.

In this embodiment the circuit 26 includes first and second auxiliary couplings 42, 44, one on each of the first and second paths 26a, 26b, for connection to the attachment 12 in order to provide hydraulic control of the attachment 12. The circuit 26 has a direction control valve 46 on the main valve block 35, for reversing the direction of flow around the circuit 26 to control movement of the attachment 12.

The circuit 26 has an auxiliary relief valve 48 on the main valve block 35. In this embodiment, the auxiliary relief valve 48 is set to activate at the same pressure as the relief valve 30, i.e. 22,000,000 Pa (220 bar). The auxiliary relief valve 48 is located on the first path 26a of the circuit 26. As the check valve 28 is located on the second path 26b of the circuit 26, the auxiliary relief valve 48 does not affect the pressure at the check valve 28.

The isolation arrangement 32 and the relief valve 30 are connected across the auxiliary couplings 42, 44, i.e. across the first 26a and second 26b paths of the circuit 26. The relief valve 30 thus acts across the first and second paths 26a, 26b of the circuit 26, when the isolation arrangement 32 is open.

The configuration of the circuit 26 is such that movement of the pins 20 to the engaged position will occur by default whenever hydraulic fluid is supplied to the attachment via the first path 26a.

The valve pressures described in relation to this embodiment are given as examples only. In alternative embodiments, the predetermined pressure at which the lock will open is set in the range of 23,000,000 Pa (230 bar) to 24,000,000 Pa (240 bar), and the relief valve actuation pressure is in the range of 21,500,000 Pa (215 bar) and 22,500,000 Pa (225 bar). Whatever the pressure range, the pressure at which the lock will open is higher than the relief valve 30 activation pressure, and is lower than the activation pressure of the main relief valve 34.

In this embodiment, the pressure differential between the predetermined pressure at which the lock will open and the activation pressure of the relief valve is 1,500,000 Pa (15 bar). The pressure differential between the activation pressure of the main relief valve and the predetermined pressure at which the lock will open is also 1,500,000 Pa (15 bar).

In an alternative embodiment, the pressure differential between the predetermined pressure at which the lock will open and the activation pressure of the relief valve is more than 1,500,000 Pa (15 bar). In an alternative embodiment, the pressure differential between the activation pressure of the main relief valve and the predetermined pressure at which the lock will open is more than 1,500,000 Pa (15 bar). In an alternative embodiment, the pressure differential between the predetermined pressure at which the lock will open and the activation pressure of the relief valve is more than 1,000,000 Pa (10 bar). In an alternative embodiment, the pressure differential between the activation pressure of the main relief valve and the predetermined pressure at which the lock will open is more than 1,000,000 Pa (10 bar).

Such a pressure differential provides adequate protection from pressure spikes (e.g. as could be caused by the attachment meeting resistance during operation) that could otherwise cause the valves to malfunction. For example, with a pressure differential that is too small, the relief valves may not open quickly enough to avoid damage should a pressure spike occur.

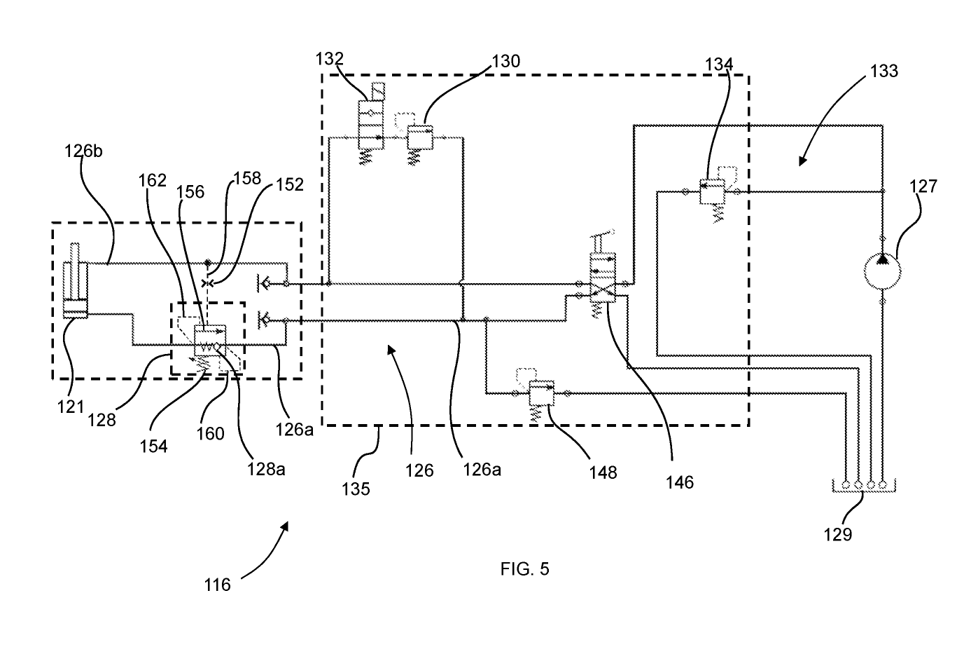

FIG. 5 shows a further embodiment of the invention, with an alternative lock 128. Features corresponding to those of the previous embodiment are given corresponding reference numbers, with an additional preceding “1”. Only features that differ from those of the first embodiment are discussed in more depth.

The lock of this embodiment is, as in the first embodiment, a spring-loaded check valve 128 that will open only when the circuit reaches the predetermined pressure. The relief valve 130 is arranged to prevent the lock 128 opening below the predetermined pressure, as described in relation to the first embodiment.

In this embodiment, the check valve 128 is located on the first path 126a. The check valve 128 is shown in FIG. 5 in the closed position, with a spring 154 resiliently biasing the check valve 128 to this closed position. In the closed position, an internal check valve 128a allows flow towards the ram 121, but prevents flow away from the ram 121 along the first path 126a, so that the ram 121 is locked with the pins in the engaged position.

An external pilot line 158 connected to the second path 126b acts against the spring 154 to open the check valve 128 when the predetermined pressure is reached. In this embodiment, the check valve 128 is set to open when the circuit 126 reaches a pressure of 23,500,000 Pa (235 bar). In this embodiment, that is, the check valve 128 will open when the pressure in the second path 126b and the pilot line 158 reaches 23,500,000 Pa (235 bar). The check valve 128 is then moved to an open position, where a free flow return 156 allows fluid to flow away from the ram 121, so that the ram 121 is no longer locked with the pins in the engaged position.

In alternative embodiments, some other suitable pressure is required to overcome the resilient bias of the spring.

In order for the second path 126b pressure, and thus the external pilot line 158 pressure, to increase over 22,000,000 Pa (220 bar), the relief valve 130 is isolated from the circuit 126 as described in the first embodiment.

Using the external pilot line 158 to operate the check valve 128 provides effective control over the check valve 128. The external pilot line 158 is also effective in locking the ram 121. In order to lock the ram 121, the relief valve 130 is returned to the circuit 126. As a result, the pressure in the external pilot line 158 drops to or below 22,000,000 Pa (220 bar), and the spring 154 can then act to close the check valve 128. The ram 121 can be moved so that the pins are in the engaged position, and the ram 121 is locked in place by fluid flowing through the internal check valve 128a towards the ram 121.

The check valve 128 of this embodiment has internal pilot lines 160, 162 which further aid control of the check valve 128. The first internal pilot line 160 acts to bias the check valve 128 towards the closed position, aiding control of the circuit when the ram 121 is to be locked in place. The second internal pilot line 162 acts to bias the check valve 128 towards the open position, aiding control of the circuit when the ram 121 is to be released.

Advantageously, with the arrangement of this embodiment, the full pressure of the circuit can be used to operate the ram 121, rather than merely the remainder of the pressure that is not expended in activating the check valve.

In alternative embodiments, the locking system has a single latching member, or three or more latching members. Multiple latching members are controlled by the same hydraulic circuit, or are controlled by individual hydraulic circuits.

Advantageously, the locking system can be retrofitted to a range of working machines, including those with multi-stage booms and single-stage booms, and those with manual hydraulics or servo hydraulics.

In alternative embodiments, the system described above is used to operate other functions of a working machine. The system is in alternative embodiments used to lock/unlock a ram used for some function other than securing an attachment to a working arm, such as a hydraulic pickup hitch at the rear of a working machine, where a ram could be used to lower the hitch. In further alternative embodiments, the system is used to operate some function other than a ram. For example, the pressure differential between the lock/control valve, the relief valve, and the main relief valve, is used to control some other function of a working machine, such as a cooling fan that starts working at a pressure of e.g. 10,000,000 Pa (100 bar). Such a system is advantageously deployed in any part of a working machine where the use of electronics is difficult and/or expensive.

Although the invention has been described above with reference to one or more preferred embodiments, it will be appreciated that various changes or modifications may be made without departing from the scope of the invention as defined in the appended claims.

1. A locking system for securing an attachment to a working arm of a working machine, the locking system comprising:
a latch member movable between an engaged position, where the attachment is secured to said working arm, and a disengaged position, where the attachment can be removed from said working arm; and
a hydraulic circuit configured to lock the latch member in the engaged position;
wherein the hydraulic circuit comprises a lock configured to open when the circuit reaches a predetermined pressure such that the latch member is released from the engaged position;
a relief valve configured to activate below the predetermined pressure, such that the lock remains closed in normal operation; and
an isolation arrangement configured to selectively isolate the relief valve from the circuit upon an operator input, to enable the circuit to reach the predetermined pressure such that the latch member is released.

2. The system according to claim 1 wherein the lock comprises a mechanical valve.

3. The system according to claim 1 wherein the lock comprises a check valve.

4. The system according to claim 1 wherein the hydraulic circuit comprises a pilot line configured to operate the lock.

5. The system according to claim 1 wherein the isolation arrangement for the relief valve is configured for remote operation.

6. The system according to claim 5 wherein the isolation arrangement comprises an electromechanical valve.

7. The system according to claim 6 wherein the electromechanical valve is a solenoid valve.

8. The system according to claim 1 wherein the pressure differential between the predetermined pressure and the activation pressure of the relief valve is more than 1,000,000 Pa (10 bar).

9. The system according to claim 1 wherein the pressure differential between the activation pressure of the main relief valve and the predetermined pressure at which the lock will open is more than 1,000,000 Pa (10 bar).

10. The system according to claim 1 further comprising a latch member actuator configured to move the latch member between the engaged and disengaged positions.

11. The system according to claim 10 comprising a first user input for operating the isolation arrangement, and a second user input for operating the latch member actuator, where the first and second user inputs are spaced such that they cannot be operated by a single hand.

12. The system according to claim 11 wherein the first user input is at least 200 mm from the second user input.

13. The system according to claim 1 wherein the hydraulic locking circuit forms part of an auxiliary circuit configured to selectively supply hydraulic fluid to an attachment to provide a function of the attachment.

14. A working machine comprising:
a working arm for mounting attachments thereto; and
a locking system for securing an attachment to a working arm of a working machine, the locking system comprising:
a latch member movable between an engaged position, where the attachment is secured to said working arm, and a disengaged position, where the attachment can be removed from said working arm; and
a hydraulic circuit configured to lock the latch member in the engaged position;
wherein the hydraulic circuit comprises a lock configured to open when the circuit reaches a predetermined pressure such that the latch member is released from the engaged position;
a relief valve configured to activate below the predetermined pressure, such that the lock remains closed in normal operation; and
an isolation arrangement configured to selectively isolate the relief valve from the circuit upon an operator input, to enable the circuit to reach the predetermined pressure such that the latch member is released.

15. The working machine according to claim 14 wherein the isolation arrangement is located on a valve block located on a main body of the working machine.

16. The working machine according to claim 14 wherein the relief valve is located on a valve block located on a main body of the working machine.

17. The working machine according to claim 14 wherein the lock is located proximal the free end of the working arm.

18. The working machine according to claim 14 wherein the locking system comprises a latch member actuator configured to move the latch member between the engaged and disengaged positions; a first user input for operating the isolation arrangement; and a second user input for operating the latch member actuator;
wherein the first and second user inputs are operable by an operator seated in an operator seat of the working machine without leaving the operator seat.

19. The working machine according to claim 18 wherein the first and second user inputs are spaced such that they cannot be operated by a single hand.

20. A method of disengaging a latch member of a locking system for securing an attachment to a working arm of a working machine, the locking system comprising: a latch member movable between an engaged position, where the attachment is secured to said working arm, and a disengaged position, where the attachment can be removed from said working arm; and a hydraulic circuit configured to lock the latch member in the engaged position; wherein the hydraulic circuit comprises a lock configured to open when the circuit reaches a predetermined pressure such that the latch member is released from the engaged position; a relief valve configured to activate below the predetermined pressure, such that the lock remains closed in normal operation; and an isolation arrangement configured to selectively isolate the relief valve from the circuit upon an operator input, to enable the circuit to reach the predetermined pressure such that the latch member is released, the method comprising the steps of:
a) isolating the relief valve from the circuit; and
b) moving the latch member to a disengaged position.
